(19) United States
(12) Patent Application Publication
(10) Pub. No.: US 2010/0214719 A1
(43) Pub. Date: Aug. 26, 2010

(54) CAPACITOR AND METHOD OF MANUFACTURING THE SAME

(75) Inventors: Woon Chun Kim, Suwon-si (KR); Sung Yi, Suwon-si (KR); Soon Gyu Yim, Seongnam-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-si (KR)

(21) Appl. No.: 12/414,030

(22) Filed: Mar. 30, 2009

(30) Foreign Application Priority Data
Feb. 25, 2009 (KR) 10-2009-0015597

(51) Int. Cl. H01G 4/06; B05D 5/12; H01G 4/10

(52) U.S. Cl. 361/313; 427/79

(57) ABSTRACT

The present invention provides a capacitor including: a bottom electrode; a first dielectric layer formed on the bottom electrode; a conductive polymer layer formed on the first dielectric layer; a second dielectric layer formed on the conductive polymer layer; and a top electrode formed on the second dielectric layer, and a method of manufacturing the same.

### CROSS-REFERENCE TO RELATED APPLICATIONS

This application claims the benefit of Korean Patent Application No. 10-2009-015597 filed with the Korea Intellectual Property Office on Feb. 25, 2009, the disclosure of which is incorporated herein by reference.

### BACKGROUND OF THE INVENTION

1. Field of the Invention

The present invention relates to a capacitor and a method of manufacturing the same; and, more particularly, to a capacitor capable of reducing dielectric loss and improving capacitance by forming two dielectric layers having different dielectric constants and a conductive polymer layer between two electrodes, and a method of manufacturing the same.

2. Description of the Related Art

A capacitor is an electronic part which includes a pair of electrodes and a dielectric interposed between the pair of electrodes to store electric energy between the pair of electrodes. Capacitance of the capacitor is in inverse proportion to a distance between the electrodes, is in proportion to areas of the electrodes, and is expressed as the following equation.

$$C = ɛ \frac{A}{d}$$

Herein, C, ε, A, and d represent capacitance, a dielectric constant, an electrode area, and a distance between the electrodes, respectively.

In order to increase the capacitance, the capacitor uses a dielectric having a high dielectric constant. However, since the dielectric having the high dielectric constant generally increases dielectric loss, there is a limit in improving the capacitance of the capacitor.

Further, in the case when the dielectric having the high dielectric constant, an insulator, or the like are used in order to reduce the dielectric loss, the entire capacitance of the capacitor is sharply reduced due to a low dielectric constant of the insulator or the like.

Therefore, a new device is required which can minimize reduction in the capacitance of the capacitor and reduce the dielectric loss.

### SUMMARY OF THE INVENTION

The present invention has been proposed in order to overcome the above-described problems and it is, therefore, an object of the present invention to provide a capacitor capable of reducing dielectric loss of the capacitor and increasing capacitance by forming first and second dielectric layers having different dielectric constants between bottom and top electrodes and by forming a conductive polymer layer between the dielectric layers, and a method of manufacturing the same.

In accordance with one aspect of the present invention to achieve the object, there is provided a capacitor including: a bottom electrode; a first dielectric layer formed on the bottom electrode; a conductive polymer layer formed on the first dielectric layer; a second dielectric layer formed on the conductive polymer layer; and a top electrode formed on the second dielectric layer.

Herein, the second dielectric layer may have a different dielectric constant from that of the first dielectric layer, wherein the first dielectric layer may have a dielectric constant smaller than the second dielectric layer.

Further, the first dielectric layer may be made of material including metallic oxide, wherein, the first dielectric layer may be made of at least one one selected from a group consisting of BiZnNb based oxide, BiTi based oxide, BiNb based oxide, BiCuNb based oxide, and BiMgNb based oxide.

Further, the second dielectric layer may be made of polymer resin and conductive material, wherein the conductive material is formed of at least one selected from a group consisting of carbon black, carbon nanotube, carbon nano-wire, carbon fiber, metal, metallic oxide, and graphite.

Further, the conductive polymer layer may be a water-dispersed conductive polymer layer or an organic-dispersed conductive polymer layer.

Further, the conductive polymer layer may be formed of polypyrrol or poly thiophene based conductive polymers.

Further, the capacitor may include a third dielectric layer which is formed between the second dielectric layer and the top electrode and has the same dielectric constant as that of the first dielectric layer.

Further, the third dielectric layer may have the dielectric constant smaller than the second dielectric layer.

Further, the capacitor may include a third dielectric layer which is formed to surround a top surface and both lateral surfaces of the second dielectric layer and has the same dielectric constant as that of the first dielectric layer.

And, in accordance with another aspect of the present invention to achieve the object, there is provided a capacitor including: a bottom electrode; a first dielectric layer formed on the bottom electrode; a conductive polymer layer formed on the first dielectric layer; a second dielectric layer formed on the conductive polymer layer; a second polymer layer formed on the second dielectric layer; a third dielectric layer formed on the second conductive polymer layer; and a top electrode formed on the third dielectric layer.

Herein, the first dielectric layer has a dielectric constant which is different from that of the second dielectric layer and is the same as that of the third dielectric layer.

Further, the first dielectric layer may have the dielectric constant smaller than the second dielectric layer.

And, in accordance with still another aspect of the present invention to achieve the object, there is provided a method of manufacturing a capacitor including the steps of: forming a first dielectric layer on a bottom electrode; forming a conductive polymer layer on the first dielectric layer; forming a second dielectric layer on the conductive polymer layer; and forming a top electrode on the second dielectric layer.

Herein, the second dielectric layer may have a different constant from that of the first dielectric layer, wherein the first dielectric layer may have a dielectric constant smaller than the second dielectric layer.

Further, the method further includes a step of: forming a third dielectric layer having the same dielectric constant as that of the first dielectric layer on the second dielectric layer before forming the top electrode on the second dielectric layer.

Further, the method further includes a step of: forming a third dielectric layer surrounding a top surface and both lateral surfaces of the second dielectric layer and having the same dielectric constant as that of the first dielectric layer before forming the top electrode on the second dielectric layer.

Further, the third dielectric layer may have the dielectric constant smaller than the second dielectric layer.

Further, the method further includes a step of: sequentially forming a second conductive polymer layer and a third dielectric layer having the same dielectric layer as that of the first dielectric layer on the second dielectric layer before forming the top electrode on the second dielectric layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view showing a structure of a capacitor in accordance with a first embodiment of the present invention;

FIG. 2 is a cross-sectional view showing a structure of a capacitor in accordance with a first modified example of the first embodiment of the present invention;

FIG. 3 is a cross-sectional view showing a structure of a capacitor in accordance with a second modified example of the first embodiment of the present invention;

FIGS. 4 to 8 are cross-sectional views sequentially illustrating processes of a method of manufacturing a capacitor in accordance with the first embodiment of the present invention; and

FIG. 9 is a cross-sectional view showing a structure of a capacitor in accordance with a second embodiment of the present invention.

### DETAILED DESCRIPTION OF THE PREFERABLE EMBODIMENTS

Embodiments of a capacitor and a method of manufacturing the same in accordance with the present invention will be described in detail with reference to the accompanying drawings. When describing them with reference to the drawings, the same or corresponding component is represented by the same reference numeral and repeated description thereof will be omitted.

### First Embodiment

### Structure of a Capacitor in Accordance with the First Embodiment

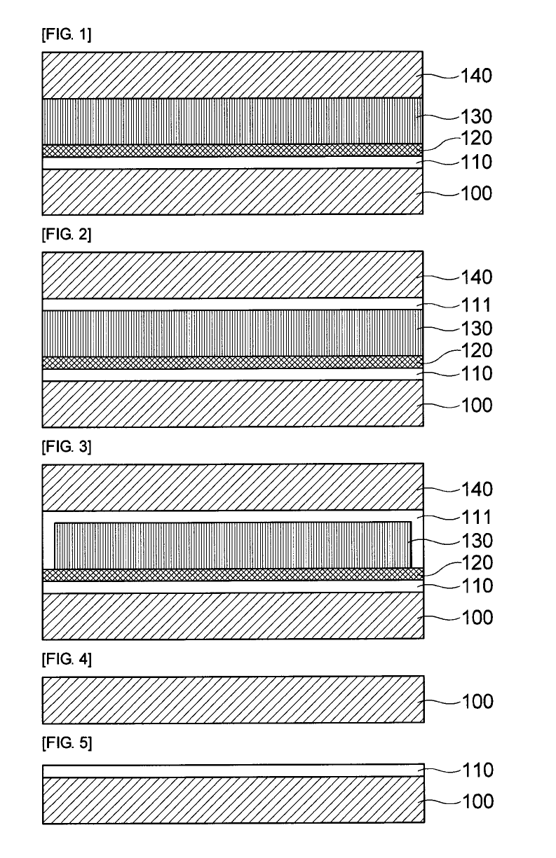

A capacitor in accordance with the first embodiment of the present invention will be described in detail with reference to FIG. 1.

FIG. 1 is a cross-sectional view showing a structure of a capacitor in accordance with the first embodiment of the present invention

As shown in FIG. 1, the capacitor in accordance with the first embodiment of the present invention includes a bottom electrode 100, a first dielectric layer 110 formed on the bottom electrode 100, a conductive polymer layer 120 formed on the first dielectric layer 110, a second dielectric layer 130 formed on the conductive polymer layer 120, and a top electrode 140 formed on the second dielectric layer 130.

The bottom electrode 100 and the top electrode 140 may be made of metal such as Cu. Further, the bottom and top electrodes 100 and 140 may be made of Ni, Al, Pt, Pd, Ta, Au, Ag, or the like as well as Cu.

And, the first dielectric layer 110 and the second dielectric layer 130 may have different dielectric constants. At this time, it is preferable that the first dielectric layer 110 has a dielectric constant smaller than the second dielectric layer 130.

The first dielectric layer 110 having the dielectric constant smaller than the second dielectric layer 130 is also low in dielectric loss compared to the second electric layer 130.

Herein, the dielectric loss means energy loss which dissipates as heat in dielectric when an electric field is applied to the dielectric, and is used as a term implying all of a dissipation factor, a leakage current, and so on.

At this time, it is preferable that the first dielectric layer 110 is made of material having a dielectric constant that is larger than that of an insulator which was conventionally used together with a dielectric having a high dielectric constant, e.g., a silicon oxide film having a dielectric constant of approximately 4, or the like, and is smaller than that of the second dielectric layer 130.

For example, the first dielectric layer 110 may be made of material including metallic oxide and, more specifically, the metallic oxide that is amorphous substance.

That is, the first dielectric layer 110 may be made of BiZnNb based oxide, BiTi based oxide, BiNb based oxide, BiCuNb based oxide, BiMgNb based oxide, or a combination of two or more among them.

Herein, as for BiZnNb based oxide, BiTi based oxide, and BiNb based oxide, Bi₅Zn₁Nb_{3/2}O₇(BZN), Bi₂Ti₂O₇(BTO), and Bi₃NbO₇(BNO) may be used, respectively. Further, as for BiCuNb based oxide and BiMgNb based oxide, Bi₂Cu_{2/3}Nb_{4/3}O₇(BCN) and Bi₂Mg_{2/3}Nb_{4/3}O₇(BMN) may be used, respectively.

And, the second dielectric layer 130 may be made of polymer resin, conductive material, and so on. That is, the second dielectric layer 130 may be a composite of the polymer resin and the conductive material. Herein, the conductive material may be formed of carbon black, carbon nanotube, carbon nano-wire, carbon fiber, metal, metallic oxide, graphite, or a combination of two or more among them.

In the embodiment of the present invention using the second dielectric layer 130 having the high dielectric constant and the first dielectric layer 110 low in the dielectric loss in comparison with the second dielectric layer 130, although the first dielectric layer 110 has the dielectric constant smaller than the second dielectric layer 130, because it has the dielectric constant larger than the insulator or the like, it is possible to reduce the entire dielectric loss of the dielectric and minimize reduction in the capacitance of the capacitor, compared to the prior art where the dielectric having the high dielectric constant and the insulator are used.

Further, as described above, in this embodiment of the present invention, the conductive polymer layer 120 is additionally formed between the first dielectric layer 110 and the second dielectric layer 130.

Since the conductive polymer layer 120 is positioned between the first and second dielectric layers 110 and 130, electrons are trapped in an interface of the conductive polymer layer 130 and therefore the conductive polymer layer 120 can play a role of a floating electrode, thereby increasing the capacitance of the capacitor. At this time, since the conductive polymer layer 120 has much lower electric conductivity than a conductor, there is little possibility that short is caused among the conductive polymer layer and the bottom and top electrodes 100 and 140.

The conductive polymer layer 120 may be a water-dispersed conductive polymer layer which is dispersed in water or an organic-dispersed conductive polymer layer which is dispersed in an organic solvent. At this time, the conductive polymer layer 120 may be formed of polypyrrol or poly thiophene based conductive polymers, or the like.

As described above, the capacitor in accordance with the embodiment of the present invention can reduce the dielectric loss of the capacitor and increase the capacitance by using the first and second dielectric layers 110 and 130 having the different dielectric constants and the conductive polymer layer 120 formed therebetween.

### FIRST MODIFIED EXAMPLE

A first modified example of the first embodiment of the present invention will be described with reference to FIG. 2. Description of the same configuration of the first modified example of the first embodiment as that of the first embodiment will be omitted and only different configuration of the first modified example will be described in detail.

FIG. 2 is a cross-sectional view showing a structure of a capacitor in accordance with the first modified example of the first embodiment of the present invention.

As shown in FIG. 2, the capacitor in accordance with the first modified example of the first embodiment of the present invention includes most of the same components as those of the capacitor of the first embodiment as described above, only it is different from the capacitor of the first embodiment in that a third dielectric layer 111 having the same dielectric constant as that of the first dielectric layer 110 is further formed between the second dielectric layer 130 and the bottom electrode 140.

In other words, since similar to the first dielectric layer 110, the third dielectric layer 111 has a dielectric constant smaller than the second dielectric layer 130 and is made of material which is low in dielectric loss, it is possible to further reduce the entire dielectric loss of the capacitor.

### SECOND MODIFIED EXAMPLE

A second modified example of the first embodiment of the present invention will be described with reference to FIG. 3. Description of the same configuration of the second modified example as that of the first embodiment will be omitted and only different configuration of the second modified example will be described in detail.

FIG. 3 is a cross-sectional view showing a structure of a capacitor in accordance with the second modified example of the first embodiment of the present invention.

As shown in FIG. 3, the capacitor in accordance with the second modified example of the first embodiment of the present invention includes most of the same components as those of the capacitor of the first embodiment as described above, only it is different from the capacitor of the first embodiment in that a third dielectric layer 111 surrounding a top surface and both lateral surfaces of the second dielectric layer 130 formed on the conductive polymer layer 120 is further provided.

Herein, as described above, the third dielectric layer 111 may have the same dielectric constant as that of the first dielectric layer 110 and be made of material having a dielectric constant smaller than that of the second dielectric layer 130.

Therefore, the second modified example can achieve the same operation and effect as those of the first embodiment and in addition, it can effectively reduce the entire dielectric loss of the capacitor by forming the third dielectric layer 110 to surround the top surface and the both lateral surfaces of the second dielectric layer 130.

### Method of Manufacturing a Capacitor in Accordance with the First Embodiment

Hereinafter, a method of manufacturing a capacitor in accordance with the first embodiment of the present invention will be described.

FIGS. 4 to 8 are cross-sectional views sequentially illustrating processes of a method of manufacturing a capacitor in accordance with the first embodiment of the present invention.

At first, as shown in FIG. 4, a bottom electrode 100 is prepared. The bottom electrode 100 may be made of Cu, Ni, Al, Pt, Pd, Ta, Au, Ag, or the like.

Thereafter, as shown in FIG. 5, a first dielectric layer 110 is formed on the bottom electrode 100. The first dielectric layer 110 may be formed at a thickness of less than 1 μm by a method such as sputtering.

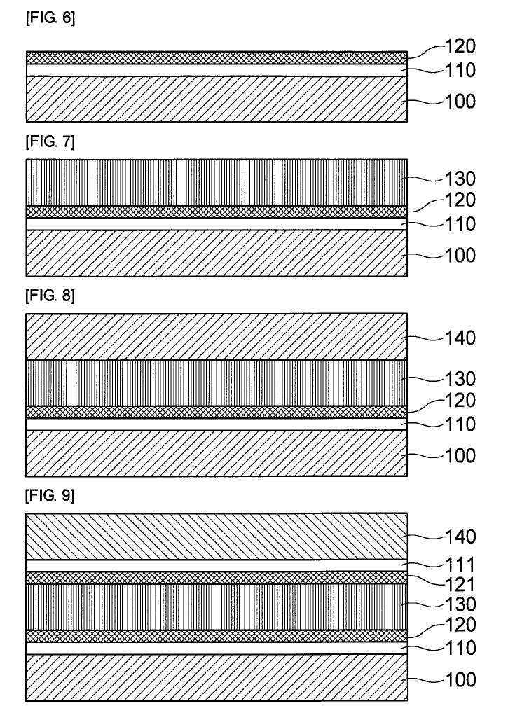

Thereafter, as shown in FIG. 6, a conductive polymer layer 120 is formed on the first dielectric layer 110. For instance, the conductive polymer layer 120 may be a water-dispersed conductive polymer layer which is dispersed in water or an organic-dispersed conductive polymer layer which is dispersed in an organic solvent. At this time, the conductive polymer layer 120 may be formed by coating polypyrrol or poly thiophene based conductive polymers, or the like.

Thereafter, as shown in FIG. 7, a second dielectric layer 130 is formed on the conductive polymer layer 120. The second dielectric layer 130 may be formed by printing dielectric paste, or the like.

Further, the second dielectric layer 130 may be formed at a thickness larger than that of the first dielectric layer 110, e.g., a thickness of several tens of micrometers to several hundred micrometers in order to prevent short.

Thereafter, as shown in FIG. 8, a top electrode 140 is formed on the second dielectric layer 130. The top electrode 140 may be made of Cu, Ni, Al, Pt, Pd, Ta, Au, Ag, or the like and be formed by a method such as sputtering or vacuum evaporation.

Meanwhile, before forming the top electrode 140 on the second dielectric layer 130, a third dielectric layer 111 may be additionally formed on the second dielectric layer 130, wherein the third dielectric layer 111 has a dielectric constant which is equal to that of the first dielectric layer 110 and is smaller than that of the second dielectric layer 130 (see FIG. 2).

Similar to the first dielectric layer 110, the third dielectric layer 111 may be formed at a thickness of less than of 1 μm by a method such as sputtering.

At this time, the third dielectric layer 111 may be formed to surround a top surface and both lateral surfaces of the second dielectric layer 130 (see FIG. 3).

### Second Embodiment

### Structure of a Capacitor in Accordance with a Second Embodiment

A capacitor in accordance with the second embodiment of the present invention will be described in detail with reference to FIG. 9. Description of the same configuration of the second embodiment as that of the first embodiment will be omitted and only different configuration of the second embodiment will be described in detail.

FIG. 9 is a cross-sectional view showing a structure of a capacitor in accordance with the second embodiment of the present invention.

The capacitor in accordance with the second embodiment of the present invention, as shown in FIG. 9, includes most of the same components as those of the capacitor of the first embodiment, only it is different from the capacitor of the first embodiment in that a second conductive polymer layer 121 and a third dielectric layer 111 having the same dielectric constant as that of the first dielectric layer 110 are sequentially formed between the second dielectric layer 130 and the top electrode 140.

Similar to the conductive polymer layer 120, the second conductive polymer layer 121 may be formed of a polypyrrol or poly thiophene based water-dispersed or organic-dispersed conductive polymer layer, and so on.

The capacitor in accordance with the second embodiment of the present invention can achieve the same operation and effect as those of the first embodiment.

### Method of Manufacturing a Capacitor in Accordance with the Second Embodiment

Hereinafter, a method of manufacturing a capacitor in accordance with the second embodiment of the present invention will be described. Description of the same configuration of the second embodiment as that of the first embodiment will be omitted and only different configuration of the second embodiment will be described in detail.

At first, as shown in FIGS. 4 to 7, a first dielectric layer 110, a conductive polymer layer 120, and a second dielectric layer 130 are sequentially formed on a bottom electrode 100.

Thereafter, after sequentially forming a second conductive polymer layer 121 and a third dielectric layer 111 on the second dielectric layer 130, a top electrode 140 is formed on the third dielectric layer 111 to thereby manufacture the capacitor in accordance with the second embodiment of the present invention as shown in FIG. 9.

Herein, the third dielectric layer 111 may be made of material having the same dielectric constant as that of the first dielectric layer 110 and be formed at a thickness of less than 1 μm by a method such as sputtering.

As described above, the capacitor and the method of manufacturing the same in accordance with the present invention can reduce the dielectric loss such as the leakage current of the capacitor by forming the first electric layer low in the dielectric loss and the second dielectric layer having the high dielectric constant between the bottom electrode and the top electrode and by forming the conductive polymer layer between the first dielectric layer and the second dielectric layer.

Further, in accordance with the present invention, since the conductive polymer layer formed between the first and second dielectric layers can play the role of the floating electrode, it is possible to increase the capacitance of the capacitor.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A capacitor comprising:
a bottom electrode;
a first dielectric layer formed on the bottom electrode;
a conductive polymer layer formed on the first dielectric layer;
a second dielectric layer formed on the conductive polymer layer; and
a top electrode formed on the second dielectric layer.

2. The capacitor of claim 1, wherein the second dielectric layer includes a dielectric constant different from a dielectric constant of the first dielectric layer.

3. The capacitor of claim 2, wherein the first dielectric layer includes the dielectric constant smaller than the second dielectric layer.

4. The capacitor of claim 3, wherein the first dielectric layer is made of material including metallic oxide.

5. The capacitor of claim 4, wherein the first dielectric layer is made of at least one selected from a group consisting of BiZnNb based oxide, BiTi based oxide, BiNb based oxide, BiCuNb based oxide, and BiMgNb based oxide.

6. The capacitor of claim 3, wherein the second dielectric layer is made of polymer resin and conductive material.

7. The capacitor of claim 6, wherein the conductive material is formed of at least one selected from a group consisting of carbon black, carbon nanotube, carbon nano-wire, carbon fiber, metal, metallic oxide, and graphite.

8. The capacitor of claim 1, wherein the conductive polymer layer is a water-dispersed conductive polymer layer or an organic-dispersed conductive polymer layer.

9. The capacitor of claim 8, wherein the conductive polymer layer is formed of polypyrrol or poly thiophene based conductive polymers.

10. The capacitor of claim 1, further comprising:
a third dielectric layer which is formed between the second dielectric layer and the top electrode and includes the same dielectric constant as the dielectric constant of the first dielectric layer.

11. The capacitor of claim 10, wherein the third dielectric layer includes the dielectric constant smaller than the second dielectric layer.

12. The capacitor of claim 1, further comprising:
a third dielectric layer which is formed to surround a top surface and both lateral surfaces of the second dielectric layer and includes the same dielectric constant as the dielectric constant of the first dielectric layer.

13. A capacitor comprising:
a bottom electrode;
a first dielectric layer formed on the bottom electrode;
a conductive polymer layer formed on the first dielectric layer;
a second dielectric layer formed on the conductive polymer layer;
a second polymer layer formed on the second dielectric layer;
a third dielectric layer formed on the second conductive polymer layer; and
a top electrode formed on the third dielectric layer.

14. The capacitor of claim 13, wherein the first dielectric layer includes a dielectric constant which is different from a dielectric constant of the second dielectric layer and is the same as a dielectric constant of the third dielectric layer.

15. The capacitor of claim 14, wherein the first dielectric layer includes the dielectric constant smaller than the second dielectric layer.

16. A method of manufacturing a capacitor comprising the steps of:
forming a first dielectric layer on a bottom electrode;
forming a conductive polymer layer on the first dielectric layer;
forming a second dielectric layer on the conductive polymer layer; and
forming a top electrode on the second dielectric layer.

17. The method of claim 16, wherein the second dielectric layer includes a different constant from a dielectric constant of the first dielectric layer.

18. The method of claim 17, wherein, the first dielectric layer includes the dielectric constant smaller than the second dielectric layer.

19. The method of claim 16, further comprising a step of:
forming a third dielectric layer including the same dielectric constant as the dielectric constant of the first dielectric layer on the second dielectric layer before forming the top electrode on the second dielectric layer.

20. The method of claim 16, further comprising a step of:
forming a third dielectric layer surrounding a top surface and both lateral surfaces of the second dielectric layer and including the same dielectric constant as the dielectric constant of the first dielectric layer before forming the top electrode on the second dielectric layer.

21. The method of claim 20, wherein the third dielectric layer includes the dielectric constant smaller than the second dielectric layer.

22. The method of claim 16, further comprising a step of:
sequentially forming a second conductive polymer layer and a third dielectric layer including the same dielectric layer as the dielectric constant of the first dielectric layer on the second dielectric layer before forming the top electrode on the second dielectric layer.
